(19) United States
(12) Patent Application Publication
(10) Pub. No.: US 2020/0086685 A1
(43) Pub. Date: Mar. 19, 2020

(54) Motorized Axle and Vehicle Equipped with Such an Axle

(71) Applicant: LOHR INDUSTRIE, Hangenbieten (FR)

(72) Inventors: Jean-Luc ANDRE, Molsheim (FR); Jacques OBER, Strasbourg (FR)

(21) Appl. No.: 16/615,473

(22) PCT Filed: Jun. 25, 2018
(86) PCT No.: PCT/EP2018/066993

§ 371 Date: Nov. 21, 2019

(30) Foreign Application Priority Data
Jun. 23, 2017 (FR) 1755805

(51) Int. Cl. B60B 35/12; B60B 35/16

(52) U.S. Cl. CPC B60B 35/122; B60K 1/02; B60B 35/16

(57) ABSTRACT

The invention relates to a motorized axle for a vehicle comprising a casing incorporating a rotational movement transmission, on each side of the casing, an axle piece comprising a free end equipped with a hub and another end mounted on said casing, each axle piece comprising members for establishing a kinematic link between the corresponding hub and the rotational movement transmission, an electric, pneumatic or hydraulic motor mounted on the casing, having an axis of rotation parallel to the axis of the axle, said motor being connected to the rotational movement transmission by means of a kinematic link that can be at least partially disengaged and at least one auxiliary device of said vehicle, able to be driven by said motor.

### TECHNICAL FIELD

The present invention relates to the general technical field of vehicles, for example standard or specific trailer, semi-trailer type road vehicles, for example of car carrier type, or for example wagon or carriage-type rail vehicles.

The invention also concerns the technical field of vehicles comprising an axle connected to an electric, hydraulic or pneumatic motor driving it at least intermittently.

The present invention relates to a central axle mechanism, in particular for a trailer axle, wherein the axle is connected to an electric, hydraulic or pneumatic motor to rotationally drive said axle and/or an auxiliary device of such road vehicles.

### BACKGROUND OF THE DISCLOSURE

It is known how to equip a trailer or semi-trailer with an electric motor, which transmits a torque to an axle, especially during the acceleration phases of said vehicle.

Such an axle connected to an electric motor often has drawbacks related to a large mass and a large overall size, as well as the need to install the motor on the chassis of the vehicle.

This arrangement requires major adaptations of the chassis and the addition of a transmission between the motor and the axle.

Furthermore, standard motor axles generally incorporate an epicyclic gearbox on the wheel, making them hardly compatible with all pneumatic tires.

These complex mechanical solutions usually include two reducers in the wheels and a bevel gear set at the input.

These arrangements make it hard to incorporate these axles into existing road vehicles without significantly modifying the chassis.

These solutions have significant rotating masses, causing a damaging loss of performance with regard to motor efficiency. It is generally impossible to disengage the electric motor from the wheel, which can raise safety issues for electric hybridization applications using permanent magnet electric motors.

These axles are generally not designed to power auxiliary devices, for example a pneumatic or hydraulic pump needed to operate certain vehicles, or, for example, an alternator or a compressor for refrigeration.

Also known via document WO 2017/081377 is a powertrain for an automotive vehicle wherein first and second accessories are incorporated into the casing of the gear motor system and are connected in series to each another via a mechanical transmission device. The accessories are arranged inside the casing and are driven continuously. Such a design has many drawbacks, especially a lack of access and a conspicuous absence of flexibility when using and operating said accessories.

### SUMMARY OF THE DISCLOSURE

The objective of this invention is therefore to overcome the drawbacks of the prior art by providing a new motorized axle for a road or rail vehicle.

Another objective of this invention is to provide a new motorized axle including an optimized central mechanism.

Another objective of this invention is to provide a new motorized axle that allows guaranteeing, in all operating configurations, the integrity of the electric motor in the event a permanent magnet motor is used.

Another objective of this invention is to provide a new motorized axle designed to be mounted simply and reliably on a new vehicle or on a second-hand vehicle to replace an old axle.

Another objective of this invention is to provide a new motorized axle whose optimized central mechanism has reduced overall size and mass.

A further objective of this invention is to provide a new motorized axle whose central mechanism has a simplified transmission architecture and wherein the rotating masses are reduced.

The objectives assigned to this invention are achieved by means of a motorized axle for a road or rail vehicle comprising at least one electric, pneumatic or hydraulic motor including a rotating shaft, at least one power supply system for said motor and at least one auxiliary device comprising at least one rotating member or being driven by one rotating member accessible from outside the casing, said motorized axle being characterized in that it comprises a central mechanism comprising:

a casing;

two axle pieces located opposite the casing, at least one of which contains a shaft connected to a wheel;

a first mechanical interface provided on each side of the casing to attach it to one of the axle pieces;

a second mechanical interface provided to attach at least one motor to the casing;

an additional mechanical interface to attach the auxiliary device to the casing;

a rotational movement transmission located in the casing and provided so as to be connected to one or two shafts in order to transmit rotational movement, and especially to rotationally drive said shafts;

a kinematic drive link arranged in the casing and provided to establish a kinematic link that can be disengaged between the rotating shaft and the rotational movement transmission and the rotating member, the rotational movement transmission and the rotating member may or may not be driven simultaneously when said kinematic drive link is in a disengaged condition.

According to an embodiment, the rotational movement transmission comprises a differential.

According to an embodiment, the rotating member is a power take-off.

According to an embodiment, the kinematic drive link comprises at least one engaging device.

According to an embodiment, the kinematic drive link comprises at least one dog clutch arranged on the rotating shaft.

According to a first advantageous embodiment, the kinematic drive link comprises two dog clutches arranged in series on the rotating shaft.

According to another advantageous embodiment, the kinematic drive link comprises three dog clutches arranged in series on the rotating shaft.

According to an embodiment of the motorized axle, a reducer is arranged in the casing between the rotational movement transmission and the motor and/or between at least one auxiliary device and the motor.

According to an embodiment of the motorized axle, an additional reducer is arranged in the casing between the motor and the auxiliary device.

According to an embodiment of the motorized axle, each axle piece is bolted to the casing.

According to an embodiment of the motorized axle, the electric, pneumatic or hydraulic motor is advantageously added onto and attached to the casing.

According to an embodiment of the motorized axle, the shaft of the axle pieces is parallel to the rotating shaft of the motor.

According to an embodiment of the motorized axle, the electric, hydraulic or pneumatic motor is configured to operate reversibly, so as to enable recharging the power supply system.

The objectives assigned to the invention are also achieved by means of a road vehicle trailer equipped with at least one motorized axle as set forth above.

The objectives assigned to the invention are also achieved by means of a road or rail vehicle equipped with at least one motorized axle as set forth above.

The central mechanism according to the invention has the enormous advantage of being able to supply electric, hydraulic or pneumatic power, for example to a trailer equipped with such an axle, during the acceleration phases. Another advantage of the present invention is the ability to rotationally drive an auxiliary device, for example a hydraulic or pneumatic device, via the electric, hydraulic or pneumatic device mounted on said axle, the vehicle equipped with the invention may be either stationary or moving.

Another advantage of the invention is that it can be mounted, without major modifications, on all trailer or semi-trailer vehicles.

A further advantage of the invention is that it guarantees safe operation, in particular by enabling the electric, hydraulic or pneumatic motor to be disengaged from the wheels. The motor will then no longer be rotationally driven by the wheels of the motorized axle. When the motor is a permanent magnet electric motor, it is difficult, in the event of a problem, to cut off the flow generated. As a result of this disengaging or declutching, the motor is kinematically neutral and no longer turns and hence no longer generates electric current.

Another advantage is being able to reduce the rotating masses. Reducing the inertia then enables the drag to be reduced. Thus, when the electric motor is generating current and the battery is charged, the motor and the auxiliary device are isolated by disengaging or declutching, thus reducing the drag.

Another advantage of the present invention is the ability to incorporate a source of electric, hydraulic or pneumatic power, such as a battery or accumulator of hydraulic or pneumatic power into a trailer or semi-trailer and make it energy independent. For example, to operate auxiliary devices driven by the hydraulic or pneumatic motor mounted on the axle. This is especially advantageous to perform loading/unloading operations, for example of a car carrier vehicle, when a trailer or semi-trailer is no longer attached to its towing vehicle. By way of example, the invention can also power the jack of a trailer body or drive the revolving drum of a mixer.

Another advantage of the invention is the ability, during taxi, to drive a load such as a pump, an alternator, a retarder or any other similar device, without creating left-right unbalance; this is achieved thanks to the differential and with the desired reduction ratio. In such circumstances, the motor, for example an electric motor, is declutched or disengaged and the corresponding load is driven by the wheels only.

### BRIEF DESCRIPTION OF THE FIGURES

Other features and advantages of the invention will appear more clearly from the following detailed description, drawn up with reference to the appended drawings, provided by way of non-restrictive examples, in which:

FIG. 1 is an illustration of a semi-trailer including an axle equipped with a central mechanism according to the invention;

FIG. 2 is a perspective view of an embodiment of the axle equipped with a central mechanism according to the invention;

FIGS. 3, 4 and 5 are kinematic representations in different operating conditions of a first embodiment of an axle equipped with a central mechanism according to the invention;

FIGS. 6, 7, 8 and 9 are kinematic representations in different operating conditions of a second embodiment of an axle equipped with a central mechanism according to the invention; and

FIGS. 10 11, 12, 13 and 14 are kinematic representations in different operating conditions of a third embodiment of an axle equipped with a central mechanism according to the invention.

### DETAILED DESCRIPTION

Hereinafter, a structurally and operationally identical element, shown in the various figures, is assigned a single numerical or alphanumerical reference.

Hereinafter, the use of the terms “that can be disengaged” or “in a disengaged condition” should be understood in the broad sense, i.e. “not providing movement transmission”. These terms can therefore also concern dog clutches and not only engaging devices.

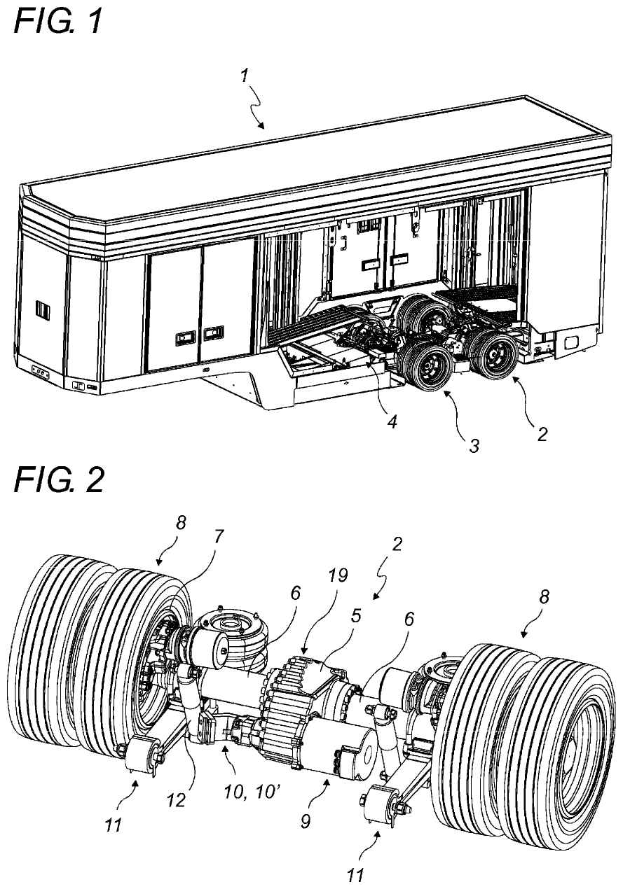

FIG. 1 illustrates a semi-trailer vehicle 1 shown partially transparent to display an axle 2 equipped with a central mechanism according to the invention connected to a standard axle 3 and a power system 4 incorporated into the lower portion of said semi-trailer. Alternatively, the axle 2 equipped with a central mechanism according to the invention can also equip a trailer not shown in the figures, or any other road or rail vehicle.

Indeed, the vehicle 1 can be any type of road or rail vehicle. It is preferentially a trailer or a semi-trailer, for example a trailer or a semi-trailer of a car carrier.

FIG. 2 shows an external perspective view of an embodiment of the axle 2 equipped with a central mechanism according to the invention. This embodiment includes a central casing 5 incorporating a rotational movement transmission 19. The rotational movement transmission 19 can be mechanical including, for example, at least gears, a belt and/or a chain. The rotational movement transmission 19 can be hydraulic, pneumatic or any other known type.

The axle 2 equipped with a central mechanism according to the invention also includes two hollow axle pieces 6 connected to the casing 5 by one of their ends, for example by bolting or welding. The other end of the axle pieces 6 comprises a hub 7 whereon a wheel 8 is mounted. The embodiment of this wheel can take the form of a single or double wheel. The axle pieces 6 can be in one piece with the casing 5.

The axle 2 equipped with a central mechanism according to the invention also includes an electric, hydraulic or pneumatic motor 9 mounted on the casing 5 and having a rotating shaft 9a parallel to the axis of the axle 2 equipped with a central mechanism according to the invention. The motor 9 is able to drive the wheels 8 and/or one or more auxiliary devices 10 of the vehicle 1. An auxiliary device 10 is, for example, a pneumatic or hydraulic system.

The rotating member 10a advantageously constitutes the rotating shaft of the auxiliary device 10. According to another embodiment, the rotating shaft 10a constitutes a power take-off accessible from the outside of the casing 5 and able to be coupled to the auxiliary device 10.

By way of example, the hydraulic system is a hydraulic pump 10′ mounted on the casing 5, for example in the extension of the electric, hydraulic or pneumatic motor 9. Each auxiliary device 10 preferentially comprises at least one rotating member 10a, for example provided to be rotationally driven by the motor 9 or by rotation of the wheels 8.

Advantageously, the electric, hydraulic or pneumatic motor 9 can operate reversibly, so as to be able to recharge the power system 4, for example during the braking phases.

The axle 2 equipped with a central mechanism according to the invention comprises at least one wheel 8 mounted on each axle piece 6. Advantageously, it also includes a braking system, a suspension system 11 and a damping system 12. These systems are known per se and are therefore not described further.

The power supply system 4 is rechargeable and is embedded in the vehicle 1. It is provided to supply the motor 9 with electric, pneumatic or hydraulic power. The power supply system 4 advantageously includes at least one electric or super-capacity battery type power source, or at least one hydraulic or pneumatic accumulator.

According to a first variant of the invention, the axle pieces 6 attached to the casing 5 each include a shaft 6a establishing the kinematic link between the hub 7 and the rotational movement transmission 19 of the casing 5.

According to an embodiment, the attached axle pieces 6 and the casing 5 can be made in one piece, for example in a foundry or several foundry parts welded together, incorporating the axle pieces 6 and the casing 5 without a bolt attachment.

Likewise, the casing 5 can be made in two parts, for example to enable the transmission elements to be mounted.

The electric, hydraulic or pneumatic motor 9 is connected to the rotational movement transmission 19 via a kinematic link that can be at least partially disengaged, comprising, for example, a disengaging or dog clutch device. It is important to provide a disengaging or dog clutch device between the motor 9 and the differential so as to drive the load or a stationary auxiliary device 10, without driving the wheels 8. De facto, said disengaging or dog clutch device can be provided in several locations.

The kinematic link that can be at least partially disengaged is provided so that the kinematic link between the motor 9 and the rotational movement transmission 19 and/or between said motor 9 and the rotating member 10a of the auxiliary device 10 can be activated and deactivated.

It enables the rotating shaft 9a of the motor 9 to be coupled or uncoupled to a shaft 6a connected to a wheel 8 and the rotating shaft 9a of the motor 9 to the rotating member 10a of the at least one auxiliary device 10.

According to an embodiment, the rotational movement transmission 19 can have several reduction ratios, such as a gearbox. The disengaging or dog clutch device, as well as a potential synchronization device, are not necessarily required if the ratio is changed when stationary or without a load.

According to an embodiment of the invention, a transmission and a differential are incorporated into the rotational movement transmission 19.

Advantageously, the rotational movement transmission 19 incorporates a reducer between the rotating shaft 9a of the motor 9 and the shaft 6a of the axle pieces 6. For example, it can be carried out in one, two or three stages to adapt the speed of the motor 9 to the speed of the wheels 8 according to the specific features of the motor 9. It is also possible to have a reducer between the shaft of the motor 9 and the rotating member 10a of the auxiliary device 10.

The kinematic link that can be at least partially disengaged between the rotational movement transmission 19 and the motor 9 advantageously includes a disengaging or dog clutch device incorporated into the casing 5. Such a disengaging or dog clutch device enables the kinematic link between the motor 9 and the rotational movement transmission 19, and hence the wheels 8, to be activated and deactivated. Advantageously, the disengaging or dog clutch device enables the kinematic link between the motor 9 and an auxiliary device 10, for example the hydraulic pump 10′, to be activated and deactivated.

According to an embodiment of the axle 2 equipped with a central mechanism according to the invention, each hub 7 can also incorporate a reducer for greater amplification.

The kinematic link that can be at least partially disengaged of the axle 2 equipped with a central mechanism advantageously includes at least one dog clutch. According to an embodiment, the dog clutch device is advantageously connected to both a first reducer to establish the kinematic link between the electric, hydraulic or pneumatic motor 9 and the rotational movement transmission 19, and to a second reducer to establish the kinematic link between the electric, hydraulic or pneumatic motor 9 and at least one auxiliary device 10. The dogs on the dog clutch can be actuated by any known actuators. These systems are known per se and are therefore not described further. Said dogs can be replaced with engaging or dog clutch systems connected to a synchronization system.

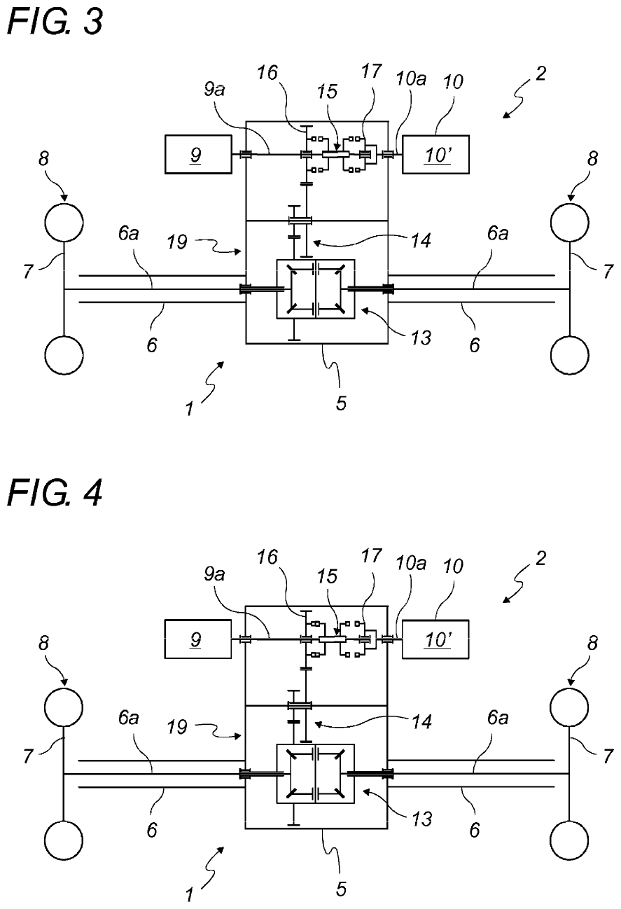

The embodiments of the axle 2 equipped with a central mechanism according to the invention, and illustrated in FIGS. 3 to 14, have a rotational movement transmission 19 that preferably comprises a differential 13 and a reducer 14, the reducer being, for example, epicyclic.

The axle pieces 6 each include a shaft 6a connecting the hub 7 to the differential 13. The transmission link between the motor 9 and the differential 13 incorporates the reducer 14. The differential 13 and the reducer 14 are both structurally and functionally known elements and are therefore not described further.

According to an embodiment, each hub 7 can include an additional reducer, separate from the reducer 14.

The kinematic link that can be at least partially disengaged from the central mechanism advantageously includes a sliding dog clutch 15 at the motor output to activate and deactivate a kinematic link between a gear wheel 16 kinematically linked to at least a wheel 8 and a dog 17, for example in the form of an auxiliary gear wheel integrated into the rotating member 10a of the auxiliary device 10. This sliding dog clutch 15 is mounted on a slide bar and is rotationally driven on the rotating shaft 9a of the motor 9. The sliding dog clutch 15 also enables the kinematic link between the gear wheel and differential 13, and hence the wheels 8, to be activated and deactivated.

According to an embodiment, the dog clutch 15 can, for example, be replaced with multiple disc clutches, or other clutches.

Likewise, declutching or disengaging the auxiliary device 10, also called a hydraulic ancillary when it is a hydraulic pump 10′, can be replaced with a flow zero setting device or with any other equivalent system.

FIGS. 3, 4 and 5 are kinematic representations corresponding to three different operating conditions of an embodiment of the axle 2 equipped with a central mechanism according to the invention. In this embodiment, the kinematic link that can be at least partially disengaged includes a dog clutch 15 mounted on a slide bar and kinematically linked to the rotating shaft 9a of the motor 9.

Thus, in a first operating condition illustrated in FIG. 3, the sliding dog clutch 15 is placed in a first position called neutral, wherein it does not engage with either the gear wheel 16 or the dog 17. This first position corresponds to a neutral position of the electric, hydraulic or pneumatic motor 9. The latter does not then transmit any rotational movement to the differential 13 and to the rotating member 10a of the auxiliary device 10. The motor 9 is not kinematically linked to any other means of the invention.

In a second operating condition illustrated in FIG. 4, the sliding dog clutch 15 is placed in a second position, wherein it engages with the gear wheel 16. This second position corresponds to a drive position for the wheels 8. The motor 9 thus transmits a mechanical torque to the wheels 8.

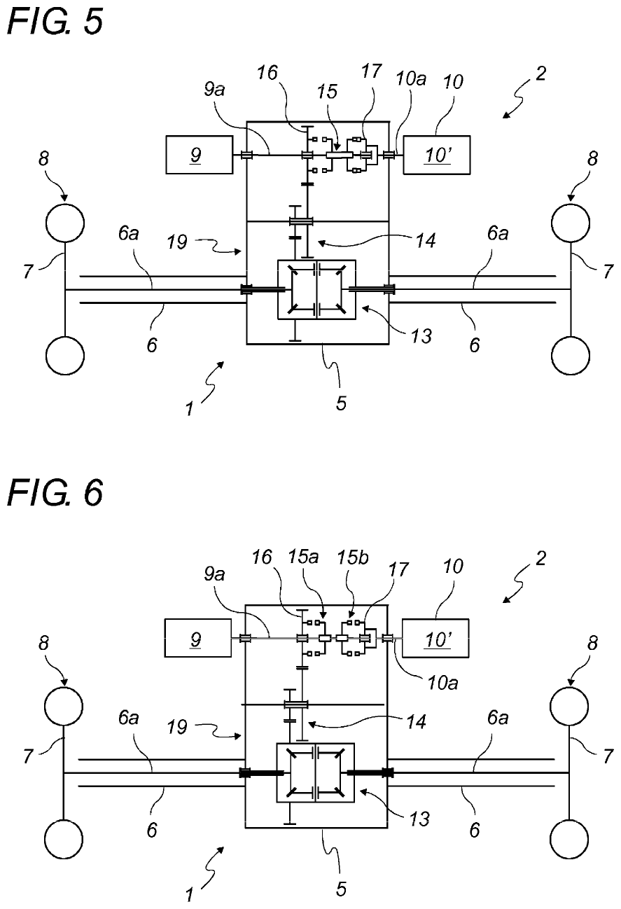

In a third operating condition illustrated in FIG. 5, the sliding dog clutch 15 is placed in a third position, wherein it engages with the dog 17. This position corresponds to a drive position for the rotating member 10a of the auxiliary device 10. The rotating member 10a can be driven at the same speed as the shaft 9a, in accordance with the diagrams or on a reduction shaft 14, depending on whether or not a reduction ratio is desired between the motor 9 and the rotating member of the auxiliary device 10.

FIGS. 6, 7, 8 and 9 are kinematic representations corresponding to four different operating conditions of another embodiment of the axle 2 equipped with a central mechanism according to the invention. In this embodiment, the kinematic link that can be at least partially disengaged includes two dog clutches 15a and 15b, these two dog clutches 15a and 15b being mounted on a slide bar and kinematically linked to the rotating shaft 9a of the motor 9.

Thus, in a first operating condition illustrated in FIG. 6, the sliding dog clutches 15a and 15b are placed in a first position called neutral, wherein they do not engage with either the gear wheel 16 or the dog 17. This first position corresponds to a neutral position of the motor 9. The latter does not then transmit any rotational movement to the differential 13 and to the rotating member 10a of the auxiliary device 10. The motor 9 is not kinematically linked to any other means of the invention.

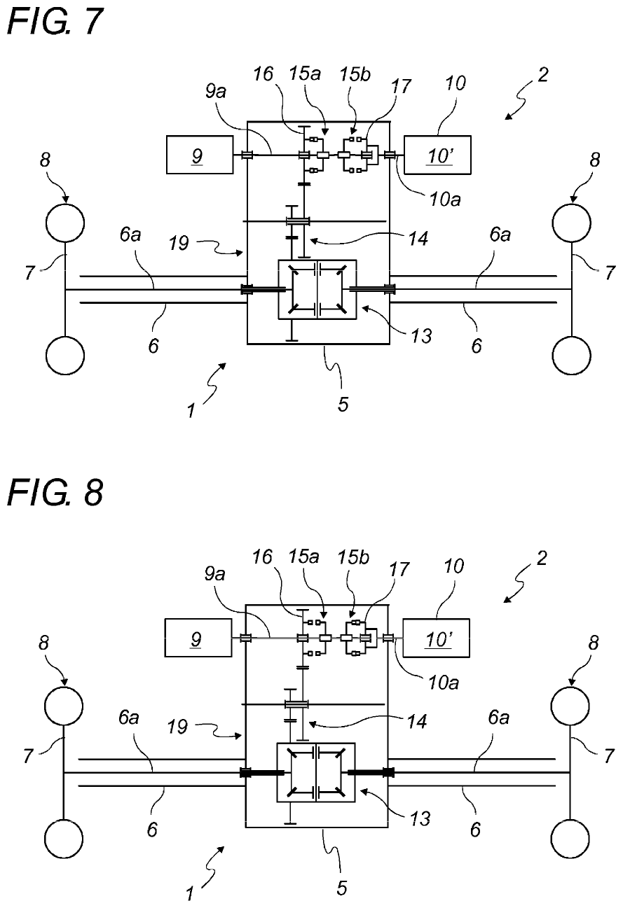

In a second operating condition illustrated in FIG. 7, the sliding dog clutch 15a is placed in a position wherein it engages with the gear wheel 16. This second position corresponds to a drive position for the wheels 8. The motor 9 thus transmits a mechanical torque to the wheels 8. The second dog clutch 15b remains in a neutral position, wherein it does not engage with the dog 17.

In a third operating condition illustrated in FIG. 8, the second sliding dog clutch 15b is placed in a position wherein it engages with the dog 17. This position corresponds to a drive position for the rotating member 10a of the auxiliary device 10. The first dog clutch 15a remains in a neutral position, wherein it does not engage with the gear wheel 16. The motor 9 does not then transmit any mechanical torque to the wheels 8.

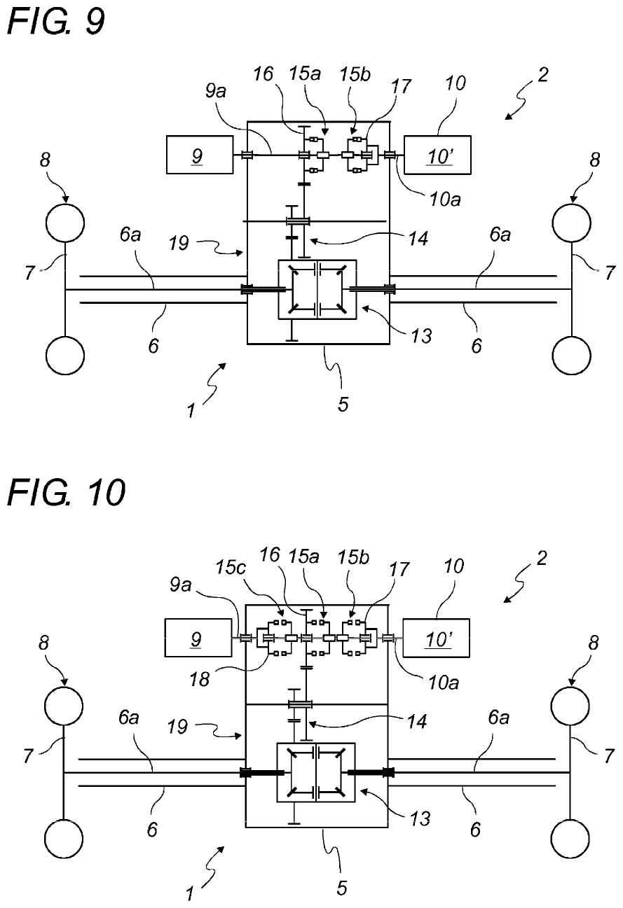

In a fourth operating condition illustrated in FIG. 9, the dog clutch 15a is placed in a position, wherein it engages with the gear wheel 16, and the second dog clutch 15b is placed in a position wherein in engages with the dog 17. This fourth position corresponds to driving the wheels 8 and the rotating member 10a of the auxiliary device 10. The motor 9 thus transmits a mechanical torque to the wheels 8 and simultaneously drives the auxiliary device (10).

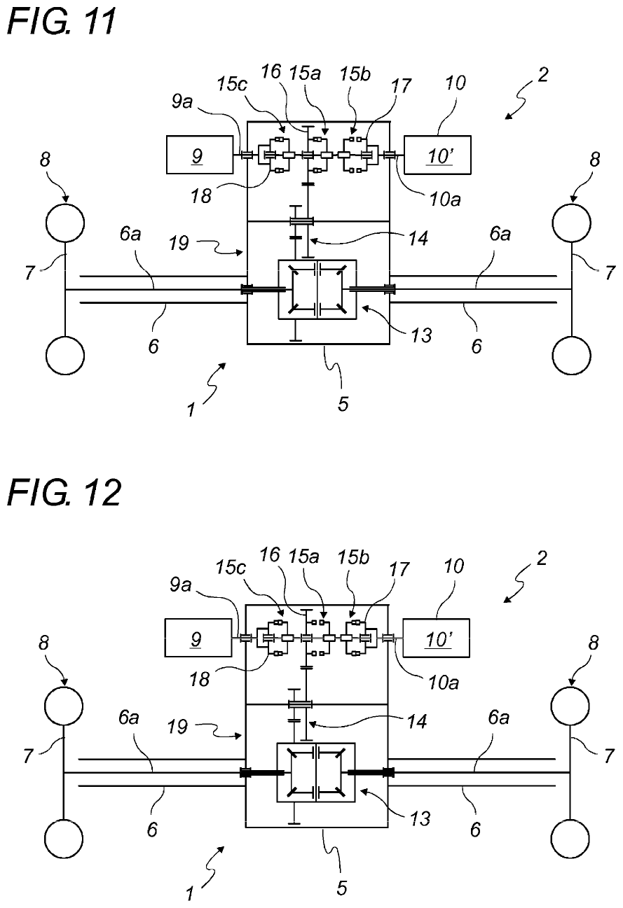

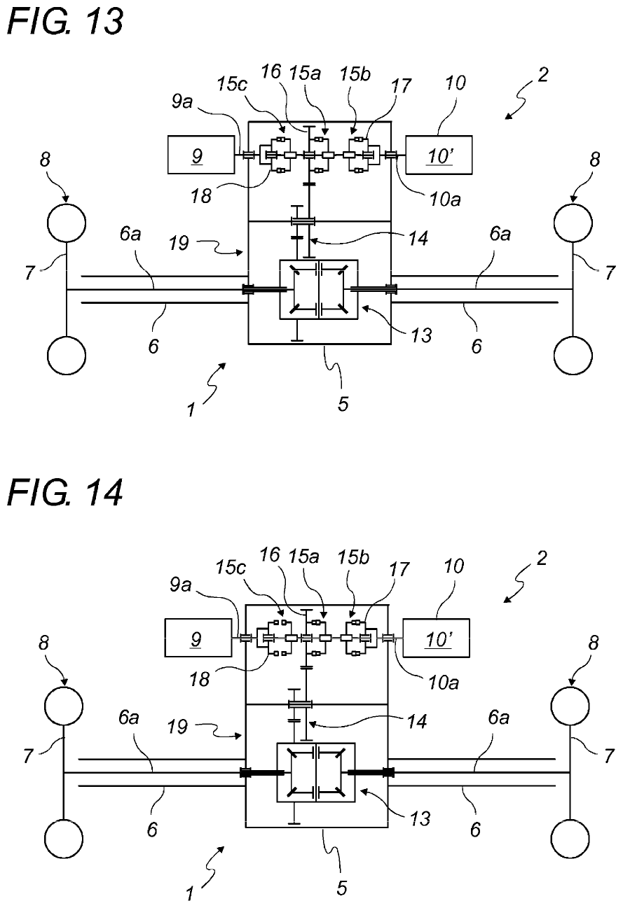

FIGS. 10, 11, 12, 13 and 14 are kinematic representations corresponding to five different operating conditions of an additional embodiment of the axle 2 equipped with a central mechanism according to the invention. In this embodiment, the kinematic link that can be at least partially disengaged comprises three dog clutches 15a, 15b and 15c mounted on slide bars and rotationally driven on the same shaft.

In this embodiment, the rotation shaft 9a of the electric, hydraulic or pneumatic motor 9 is kinematically linked to a dog 18.

The gear wheel 16 and the dog 17 are configured in a similar way to the previous variants shown in FIGS. 3 to 9.

Thus, in a first operating condition illustrated in FIG. 10, the sliding dog clutches 15a, 15b and 15c are placed in a first position called neutral, wherein they do not engage with the gear wheel 16, or the dog 17, or the dog 18. This first position corresponds to a motor isolation position 9. The latter does not then transmit any rotational movement to the differential 13 and to the rotating member 10a of the auxiliary device 10. The motor 9 is not kinematically linked to any other means of the invention.

In a second operating condition illustrated in FIG. 11, the dog clutches 15a and 15c are placed in positions wherein they engage respectively with the gear wheel 16 and with a dog 18 integrated into the rotating shaft 9a at the output of the motor 9. These positions correspond to driving the wheels 8. The motor 9 thus transmits a mechanical torque to the wheels 8. The second dog clutch 15b remains in a neutral position, wherein it does not engage with the dog 17. The rotating member of the auxiliary device 10 is therefore not driven.

In a third operating condition illustrated in FIG. 12, the dog clutches 15b and 15c are placed in positions wherein they engage respectively with the gear wheel 17 and with a dog 18 integrated into the rotating shaft 9a at the output of the motor 9. These positions correspond to driving the rotating member 10a of the auxiliary device 10. The first dog clutch 15a is in a neutral position, wherein it does not engage with the gear wheel 16. No mechanical torque is then transmitted to the wheels 8.

Thus, in a fourth operating condition illustrated in FIG. 13, the dog clutches 15a, 15b and 15c are placed in positions, wherein they engage respectively with the gear wheel 16, with the dog 17, and with the dog 18. These positions correspond to driving the rotating member 10a of the auxiliary device 10 and of the wheels 8. The motor 9 thus transmits a mechanical torque to the wheels 8 and simultaneously to the drives of the auxiliary device 10.

In a fifth operating condition illustrated in FIG. 14, the dog clutches 15a and 15b are placed in positions, wherein they engage respectively with the gear wheel 16 and with the dog 17. The third dog clutch 15c is placed in a neutral position, wherein it does not engage with the dog 18. These positions correspond to an isolation position of the motor 9. The latter does not then transmit any rotational movement to the differential 13 and to the rotating member 10a of the auxiliary device 10. The motor 9 is not kinematically linked to any other means of the invention. These positions correspond to driving the rotating member 10 via rotation of the wheels 8. This position allows driving the rotating member 10a of the auxiliary device 10 while rolling, which, for example, enables the air or oil capacities to be increased.

When an auxiliary device 10 is, for example, a hydraulic pump 10′, it can power, for example, a car-carrier lifting device.

The electric, hydraulic or pneumatic motor 9 can, for example, directly or indirectly actuate a power take-off. The latter can also be actuated by rotation of the wheels 8 when the motor 9 is in a disengaged condition or has stopped. See, for example, the operating condition illustrated in FIG. 14.

By way of example, it is conceivable in the absence of the differential 13 to have just one shaft 6a kinematically linked to the rotational movement transmission 19 and to the reducer 14. In this case, the motor 9 no longer has a traction function but only a generator function.

According to another embodiment example, it is conceivable to use a single shaft 6a connecting the two wheels 8, and without a differential 13, for specific functions. In this case, the reducer 14 is directly engaged with the shaft 6a.

The rotational movement transmission 19 may or may not incorporate a reducer to adapt the speed of the wheel 8 to the speed of the motor 9, and may or may not incorporate an auxiliary device with the previously described dog clutch functions.

Likewise, one of the dog clutches 15, 15a, 15b, 15c may be provided at another location on the kinematic chain, for example at the input of the differential 13 or on one of the gear wheels of the reducer 14. Similarly, the rotating member 10a of the auxiliary device 10 can be provided at another location on the kinematic chain, for example on one of the gear wheels of the reducer 14.

Obviously, the invention is not limited to the preferred embodiments described above and shown in the various figures, a person skilled in the art being able to make numerous modifications and imagine other embodiments without going beyond the framework and scope of the invention as defined by the claims. Thus, a described technical feature can be replaced with an equivalent technical feature, without departing from the scope specified by the claims.

1. A motorized axle for a road or rail vehicle comprising at least one electric, pneumatic or hydraulic motor comprising a rotating shaft, at least one power supply system for said motor and at least one auxiliary device comprising at least one rotating member or driven by a rotating member accessible from outside the casing, wherein the motorized axle comprises a central mechanism including:
a casing;
two axle pieces located opposite the casing, at least one of which contains a shaft connected to a wheel;
a first mechanical interface provided on each side of the casing to attach the casing to one of the axle pieces;
a second mechanical interface provided to attach at least one motor to the casing;
an additional mechanical interface to attach the auxiliary device to the casing;
a rotational movement transmission located in the casing and provided so as to be able to be connected to one shaft or both shafts in order to transmit a rotational movement;
a kinematic drive link arranged in the casing and provided to establish a kinematic link that can be disengaged between the rotating shaft and the rotational movement transmission and the rotating member, the rotational movement transmission and the rotating member may or may not be driven simultaneously when said kinematic drive link is in a disengaged condition.

2. A motorized axle according to claim 1, wherein the rotational movement transmission comprises a differential.

3. A motorized axle according to claim 1, wherein the rotating member is a power take-off.

4. A motorized axle according to claim 1, wherein the kinematic drive link comprises at least one engaging device.

5. A motorized axle according to claim 1, wherein the kinematic drive link comprises at least one dog clutch arranged on the rotating shaft.

6. A motorized axle according to claim 5, wherein the kinematic drive link comprises two dog clutches arranged in series on the rotating shaft.

7. A motorized axle according to claim 5, wherein the kinematic drive link comprises three dog clutches arranged in series on the rotating shaft.

8. A motorized axle according to claim 1, wherein a reducer is arranged in the casing between the rotational movement transmission and the motor and/or between at least one auxiliary device and the motor.

9. A motorized axle according to claim 1, wherein an additional reducer is arranged in the casing between the motor and the auxiliary device.

10. A motorized axle according to claim 1, wherein each axle piece, is bolted to the casing.

11. A motorized axle according to claim 1, wherein the electric, pneumatic or hydraulic motor, is added onto and attached to the casing.

12. A motorized axle according to claim 1, wherein the shaft of the axle pieces is parallel to the rotating shaft of the motor.

13. A motorized axle according to claim 1, wherein the electric, hydraulic or pneumatic motor is configured to operate reversibly, so as to recharge the power supply system.

14. A road-vehicle trailer equipped with at least one motorized axle according to claim 1.

15. A road or rail vehicle equipped with at least one motorized axle according to claim 1.
